(19) United States
(12) Patent Application Publication
(10) Pub. No.: US 2023/0254473 A1
(43) Pub. Date: Aug. 10, 2023

(54) APPARATUS FOR IMPROVING AN IMPACT DETECTING PERFORMANCE OF A BUILT-IN CAMERA, SYSTEM HAVING THE SAME, AND METHOD THEREOF

(71) Applicants: Hyundai Motor Company, Seoul (KR); Kia Corporation, Seoul (KR)

(72) Inventors: Jae Ryong Choi, Yongin (KR); Kyoung Jun Kim, Suwon (KR); Dong Hyuk Jeong, Hwaseong (KR); Sung Hwan Jun, Hwaseong (KR)

(21) Appl. No.: 17/903,771

(22) Filed: Sep. 6, 2022

(30) Foreign Application Priority Data
Feb. 4, 2022 (KR) 10-2022-0015027

(51) Int. Cl. H04N 17/00

(52) U.S. Cl. CPC H04N 17/002; G07C 5/0808

(57) ABSTRACT

The present disclosure relates to apparatus for improving a detection performance of a built-in cam and a method for improving a detection performance thereof. An exemplary embodiment of the present disclosure provides apparatus for improving a detection performance of a built-in cam including: a processor configured to select a control factor for determining impacts and a level of the control factor by using a ratio between effective impacts and ineffective impacts and a standard deviation of impact detection values for same impacts, wherein the ratio and the standard deviation are calculated by using data obtained from a sensor for vehicle impact detection; and a storage configured to store data and algorithms driven by the processor.

### CROSS-REFERENCE TO RELATED APPLICATION

This application is based on and claims under 35 U.S.C. § 119(a) the benefit of Korean Patent Application No. 10-2022-0015027, filed in the Korean Intellectual Property Office on Feb. 04, 2022, the entire contents of which are incorporated herein by reference.

### TECHNICAL FIELD

Embodiments of the present disclosure relate to a built-in cam impact detection improving apparatus and a method for improving a detection performance thereof, and more particularly, to a technique for improving an impact detection performance of a built-in cam.

### BACKGROUND

A built-in cam system is provided as a built-in driving video recording device in order to record a driving or parking video of a vehicle. Such a built-in cam detects an impact of the vehicle, and when the impact is detected, stores and outputs image data in conjunction with an in-vehicle display device.

However, when impact detection is sensitive, too much unnecessary image data may be stored, which results in insufficient memory capacity, while when the impact detection is insensitive, necessary impact image data may not be stored.

Accordingly, it is very important to realize optimal performance that is neither too sensitive nor too insensitive to impact detection performance of the built-in cam.

The above information disclosed in this Background section is only for enhancement of understanding of the background of the disclosure, and therefore, it may contain information that does not form the prior art that is already known in this country to a person of ordinary skill in the art.

### SUMMARY

An exemplary embodiment of the present disclosure has been made in an effort to provide a built-in cam impact detection improving apparatus and a detection performance improving method therefor, capable of increasing user satisfaction and improving reliability of a system by improving impact detection performance of the built-in cam.

The technical objects of the present disclosure are not limited to the objects mentioned above, and other technical objects not mentioned can be clearly understood by those skilled in the art from the description of the claims.

An exemplary embodiment of the present disclosure provides an apparatus for improving an impact detecting performance of a built-in cam, the apparatus including: a processor configured to select a control factor for determining impacts and a level of the control factor by using a ratio between effective impacts and ineffective impacts and a standard deviation of impact detection values for same impacts, wherein the ratio and the standard deviation are calculated by using data obtained from a sensor for vehicle impact detection; and a storage configured to store data and algorithms driven by the processor.

According to an exemplary embodiment, the processor may be configured to select the control factor and the level of the control factor by using a the-larger-the-better characteristic indicating a better characteristic as the ratio between the effective impacts and the ineffective impacts is larger and a the-smaller-the-better characteristic indicating a better characteristic as the standard deviation of the impact detection values for the same impacts is smaller.

According to an exemplary embodiment, the processor may be configured to process the data to calculate processing data for each combination of a plurality of control factors.

According to an exemplary embodiment, the processor may be configured to obtain an average of hitting values for each hitting point and hitting angle, a standard deviation of hitting values for each hitting point and hitting angle, and a number of hitting points by applying each level of the control factors.

According to an exemplary embodiment, the processor may be configured to calculate an average value of the effective impacts and an average value of the ineffective impacts based on the processing data for each level combination of the control factors, to calculate a ratio between the average value of the effective impacts and the average value of the ineffective impacts.

In an exemplary embodiment, the processor may be configured to use the average of the hitting value for each hitting point and hitting angle and the number of the hitting points for each level combination of the control factors, to calculate the ratio between the average value of the effective impacts and the average value of the ineffective impacts.

In an exemplary embodiment, the processor may be configured to select a level of the calculated control factors for which a largest value among ratios of the average value of the effective impacts and the average value of the ineffective impacts is calculated for each level combination of the control factors.

In an exemplary embodiment, the processor may be configured to calculate a standard deviation of impact detection values for the same impacts based on the processing data for each level combination of the control factors.

In an exemplary embodiment, the processor may be configured to use the standard deviation and the number of hitting points for each hitting point and hitting angle for each level combination of the control factors, to calculate the standard deviation of the impact detection values for the same impacts.

In an exemplary embodiment, the processor may be configured to select a control factor for which a smallest value among standard deviations of the impact detection values for the same impacts for each level combination of the control factors is calculated and a level of the calculated control factor.

In an exemplary embodiment, the processor may be configured to calculate an average change amount of n output values for each control factor depending on a combination of a number of the control factors and a number of levels, determines that a control factor with an average change amount of each of the control factors that is greater than or equal to a predetermined reference value has a large effect on impact detection, and selects a control factor with the average change amount that is equal to or greater than the predetermined reference value.

In an exemplary embodiment, the processor may be configured to select a level when the ratio between the average value of the effective impacts and the average value of the ineffective impacts is largest among the n output values in the selected control factor, and selects a smallest level of the standard deviation of the impact detection values among the n output values.

In an exemplary embodiment, the processor may be configured to generate an orthogonal table for each level of the control factors, and may generate an orthogonal table including numbers of cases as many as a number of levels multiplied by a number of control factors.

In an exemplary embodiment, the processor may be configured to calculate the ratio between the effective impacts and the ineffective impacts for each of the numbers of cases and the standard deviation of the impact detection values for the same impacts.

In an exemplary embodiment, the control factor may include a noise filter, integration of an impact amount, an impact amount sampling period, and a previous impact amount reference period.

In an exemplary embodiment, the processor may be configured to consider whether an engine is started, or a wiper is operated to select the control factor and a level of the control factor.

An exemplary embodiment of the present disclosure provides a method for improving an impact detecting performance of a built-in cam, the method including: acquiring data from a sensor for vehicle impact detection; and selecting a control factor for determining impacts and a level of the control factor by using a ratio between effective impacts and ineffective impacts and a standard deviation of impact detection values for same impacts, wherein the ratio and the standard deviation are calculated by using data obtained from a sensor for vehicle impact detection.

According to an exemplary embodiment, the selecting of the control factor and the level of the control factor may include selecting the control factor and the level of the control factor by using a the-larger-the-better characteristic indicating a better characteristic as the ratio between the effective impacts and the ineffective impacts is larger and a the-smaller-the-better characteristic indicating a better characteristic as the standard deviation of the impact detection values for the same impacts is smaller.

According to an exemplary embodiment, the selecting of the control factor for determining the impacts and the level of the control factor may include: processing the data to calculate processing data for each combination of a plurality of control factors; calculating an average value of the effective impacts and an average value of the ineffective impacts based on processing data for each level combination of the control factors, impact a ratio between the average value of the effective impacts and the average value of the ineffective impacts; and selecting a control factor and a level of the control factor for which a largest value among ratios of the average value of the effective impacts and the average value of the ineffective impacts is calculated for each level combination of the control factors.

In an exemplary embodiment, the selecting of the control factor for determining the impacts and the level of the control factor may further include: calculating a standard deviation of impact detection values for the same impacts based on the processing data for each level combination of the control factors; and selecting a control factor for which a smallest value among standard deviations of the impact detection values for the same impacts for each level combination of the control factors is calculated and a level of the calculated control factor.

In an exemplary embodiment, the selecting of the control factor for determining the impacts and the level of the control factor may further include: calculating an average change amount of n output values for each control factor depending on a combination of a number of the control factors and a number of levels; and determining that a control factor with an average change amount for each of the control factors that is greater than or equal to a predetermined reference value has a large effect on impact detection, and selecting a control factor with the average change amount that is equal to or greater than the predetermined reference value.

According to the present technique, it is possible to increase user satisfaction and improving reliability of a system by improving impact detection performance of the built-in cam.

In addition, various effects that can be directly or indirectly identified through this document may be provided.

As discussed, the method and system suitably include use of a controller or processer.

In another embodiment, vehicles are provided that comprise an apparatus as disclosed herein.

### BRIEF DESCRIPTION OF THE DRAWINGS

FIG. 1 illustrates a block diagram showing a configuration of a built-in cam impact detection improving apparatus according to an exemplary embodiment of the present disclosure.

FIG. 2 illustrates a flowchart showing a method of deriving a control factor for detection improving a built-in cam impact according to an exemplary embodiment of the present disclosure.

FIG. 3A and FIG. 3B illustrate views for describing an example of a difference between an effective impact and an ineffective impact in order to improve impact sensing performance of a built-in cam impact detection improving apparatus according to an exemplary embodiment of the present disclosure.

FIG. 4 illustrates a view for describing an example of a standard deviation for same impacts to improve impact detection performance of a built-in cam impact detection improving apparatus according to an exemplary embodiment of the present disclosure.

FIG. 5A illustrates a view for describing an example of calculating a data set that is processed by using raw data of a built-in cam impact detection improving apparatus according to an exemplary embodiment of the present disclosure.

FIG. 5B illustrates a view for describing an example of calculating an output value of each of Ideal function 1 and Ideal function 2 by using the processed data set of FIG. 5A.

FIG. 6A illustrates a table for describing a control factor for detection improving a built-in cam impact according to an exemplary embodiment of the present disclosure.

FIG. 6B illustrates a table for describing a noise factor for detection improving a built-in cam impact according to an exemplary embodiment of the present disclosure.

FIG. 7 illustrates a block diagram showing a process of calculating a data set that is processed by using raw data according to an exemplary embodiment of the present disclosure.

FIG. 8 illustrates an example of an orthogonal table including a number of cases for a control factor for detection improving a built-in cam impact according to an exemplary embodiment of the present disclosure.

FIGS. 9A to 9C illustrate views for describing an example of calculating an output value by Ideal function 1 according to an exemplary embodiment of the present disclosure.

FIGS. 10A to 10C illustrate views for describing an example of calculating an output value by Ideal function 2 according to an exemplary embodiment of the present disclosure.

FIG. 11 illustrates a view for describing an example of an average change amount for each control factor of Ideal function 1 and Ideal function 2 according to an exemplary embodiment of the present disclosure.

FIG. 12 illustrates a view for describing a process of finally selecting a control factor having a large influence among average change amounts of FIG. 11.

FIG. 13 illustrates a view for comparing output values of Ideal function 1 and Ideal function 2 of an optical control factor and an existing control factor according to an exemplary embodiment of the present disclosure.

FIG. 14 illustrates a computing system according to an exemplary embodiment of the present disclosure.

### DETAILED DESCRIPTION OF THE EMBODIMENTS

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

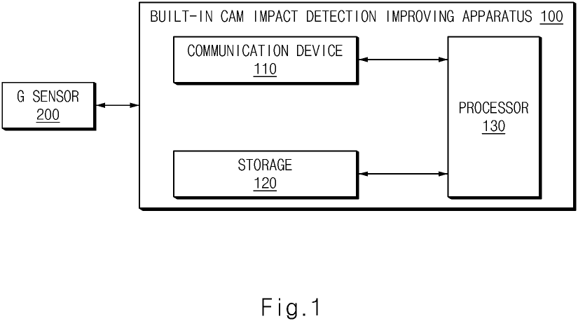

Hereinafter, exemplary embodiments of the present disclosure will be described in detail with reference to FIG. 1 to FIG. 14.

FIG. 1 illustrates a block diagram showing a configuration of a built-in cam impact detection improving apparatus according to an exemplary embodiment of the present disclosure.

The built-in cam impact detection improving apparatus 100 may determine an external force (instantaneous force) that is greater than or equal to a specific threshold as an effective impact (impact that may damage a vehicle), and when determining effective impact simply as a magnitude of the instantaneous force, may determine an impact of an undetected condition (opening or closing of a vehicle, using electrical components around the sensor) as an effective impact. Accordingly, it is very important to accurately detect an effective impact and an invalid impact.

Accordingly, the built-in cam impact detection apparatus 100 of the present disclosure optimizes signal processing logic of raw data by a G sensor to minimize erroneous impact detection or impact non-detection. The built-in cam impact detection improving apparatus 100 uses control factors such as a vector sum of an impact change amount, impact amount integration, a sampling period, and previous data reference period to optimize signal processing logic of raw data.

In addition, the built-in cam impact detection improving apparatus 100 may calculate an optimal control factor for a G sensor impact treatment through each orthogonal table analysis for Ideal function 1 and Ideal function 2, and use it for impact detection by using Ideal function 1, which derives an output value with a largest difference between the effective and non-effective impacts, and Ideal function 2, which derives an output value with a smallest standard deviation of sensed values for a same impact.

Referring to FIG. 1, the built-in cam impact detection improving apparatus 100 may include a communication device 110, a storage 120, and a processor 130.

The communication device 110 may be a hardware device implemented with various electronic circuits to transmit and receive signals through a wireless or wired connection. The communication device 110 may receive a sensing result from the external G sensor 200 and transmit it to the processor 130.

The storage 120 may store data and/or algorithms required for the processor 130 to operate, and the like. In particular, the storage 120 may store raw data of the G sensor 200 and data related to an optimal control factor, a noise factor, and the like for detecting a built-in cam impact.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The processor 130 may remove noise and acquires meaningful information through signal processing of the output value of the G sensor 200, i.e., raw data. That is, the processor 130 performs a process of mathematically processing the raw data, such as applying filter logic or converting a signal. For example, when an input of a specific frequency band among input signals is meaningful information, the processor 130 may remove or acquire a desired signal by analyzing a Fourier-transformed frequency domain signal. In this case, a technique of the Fourier transform may be determined depending on characteristics of the signal (continuous signal or discrete signal).

In addition, the processor 130 may apply a low pass filter that passes only a signal in a region below a cutoff frequency, or when noise occurs in a specific frequency band, such as vehicle engine noise or driving road noise, may apply a band pass filter or the like to remove noise from the output value of the G sensor 200.

The processor 130 may be electrically connected to the communication device 110, the storage 120, the G sensor 200, and the like, may electrically control each component, and may be an electrical circuit that executes software commands, thereby performing various data processing and calculations described below.

The processor 130 may process a signal transferred between components of the built-in cam impact detection improving apparatus 100, and may perform overall control such that each of the components can perform its function normally.

The processor 130 may be implemented in the form of hardware, software, or a combination of hardware and software, or may be implemented as microprocessor.

The processor 130 may select a control factor for determining the impact and a level of the control factor by using raw data obtained from a sensor for detecting a vehicle impact and using a the-larger-the-better characteristic of a ratio between the effective and non-effective impacts and a the-smaller-the-better characteristic of a standard deviation of impact detection values for same impacts.

In this case, the effective impact may indicate an impact that may damage the vehicle, and the ineffective impact indicates a mild impact that does not damage the vehicle and should not be detected.

In addition, the-larger-the-better characteristic may indicate a better characteristic as a desired characteristic value is larger, and the-smaller-the-better characteristic may indicate a better characteristic as a desired characteristic value is smaller.

In addition, the control factor may include a noise filter, integration of an impact amount, an impact amount sampling period, a previous impact amount reference period, and the like. The noise filter indicates a filter value for removing noise, and the integration of the impact amount indicates a condition for integrating the impact amount from which time point. For example, when the noise filter is set to 30 Hz and an integration of the impact is 60 ms, noise below 30 Hz of raw data is removed, and the impact amount from a point before 60 ms is integrated (summed).

The impact amount sampling period may indicate a sampling period for obtaining raw data of the G sensor 200, and the previous impact amount reference period may indicate a reference time for calculating the relative impact value of the G sensor 200. For example, the sampling period may be set to 10 ms, and the previous impact amount reference period may be set to an impact value before 2 samples.

The processor 130 may process the raw data to calculate processing data for each combination of a plurality of control factors. In this case, the processor 130 may perform processing of the raw data based on an algorithm such as MATLAB.

That is, the processor 130 may obtain an average of hitting values for each hitting point and hitting angle, a standard deviation of hitting values for each hitting point and hitting angle, and a number of hitting points by applying each level of multiple control factors.

The processor 130 may acquire raw data through a principle test, and may acquire information through a principle test for each of a car and an SUV vehicle in consideration of a vehicle deviation.

In addition, the processor 130 may determine 15 points, such as a front bumper, a rear bumper, and each door, as target points for each vehicle during the principle test, and may perform a same impact test even under a state of noise factors (starting condition, wiper operation or not). For example, raw data may be obtained from 1440 principle tests under a combination of various conditions.

The processor 130 may calculate an average value of effective impacts and an average value of ineffective impacts based on processing data for each level combination of the control factors, to calculate a ratio between the average value of the effective impacts and the average value of the ineffective impacts.

Equation 1 below is an equation for calculating an output value of Ideal function 1 having a ratio between the effective impacts and the ineffective impacts as a result value.

$$\begin{matrix}\text{Output value of Ideal function 1 =} \left[\sum \left(\text{for each hitting point}\right)\right) \\ \left(\text{70-degree hitting average} / \text{30-degree hitting average}\right] / \text{number of} \\ \text{hitting points}\end{matrix}$$

The processor 130 may use an average hitting value for each hitting point and hitting angle and a number of hitting points for each level combination of the control factors, to calculate a ratio between the average value of the effective impacts and the average value of the ineffective impacts.

The processor 130 may select a level of a calculated level of control factors for which a largest value among ratios of the average value of the effective impacts and the average value of the ineffective impacts is calculated.

The processor 130 may calculate a standard deviation of impact detection values for same impacts based on the processing data for each level combination of the control factors.

Equation 2 below is an equation for calculating an output value of Ideal function 2 having a standard deviation for same impacts as a result value.

$$\begin{matrix}\text{Output value of ideal function 2 =} \left[\sum \text{standard deviation} / \text{average}\right) \\ \left(\left(\text{10 times for each hitting point and angle}\right)\right] / \text{number of hitting} \\ \text{points}\end{matrix}$$

The processor 130 may use the standard deviation and the number of hitting points for each hitting point and hitting angle for each level combination of the plurality of control factors, to calculate a standard deviation of impact detection values for same impacts.

The processor 130 may select a control factor for which a smallest value among standard deviations of the impact detection values for the same impacts for each level combination of the control factors is calculated and a level of the calculated control factor.

The processor 130 may calculate an average change amount of n output values for each control factor depending on a combination of a number of the control factors and a number of levels, may determine that a control factor with an average change amount of each control factor that is greater than or equal to a predetermined reference value has a large effect on impact detection, and may select a control factor with the average change amount that is equal to or greater than the predetermined reference value.

The processor 130 may select a level when the ratio between the average value of the effective impacts and the average value of the ineffective impacts is largest among the n output values in the selected control factor, and may select a smallest level of the standard deviation of the impact detection values among the n output values.

The processor 130 may generate an orthogonal table for each level of the control factors, and may generate an orthogonal table including numbers of cases as many as a number of levels multiplied by a number of control factors.

The processor 130 may calculate a ratio between the effective impacts and the ineffective impacts depending on each of the numbers of cases and the standard deviation of the impact detection values for the same impacts.

The processor 130 may select the control factor and the level of the control factor in consideration of not only the control factor, but also whether an engine is started, or a wiper is operated.

The G sensor 200, which is an acceleration sensor, may convert a movement of internal mass of the sensor due to an external force into an electrical signal through an amount of change in capacitance, calculate an acceleration value, and transmit it to the processor 130. The G sensor 200 may calculate a magnitude of the external force in each of individual axes x, y, and z that is orthogonal to each other. In this case, gravity always may act in a specific direction, and as a posture of the G sensor 200 is inclined by θ in a roll (pitch) direction, an acceleration value measured in x-y (y-z) changes, a slope θ value may be estimated by inversely calculating the measured acceleration value.

In this case, the output value of the G sensor 200 may indicate a difference between a vector sum of x, y, and z values before a reference time and a vector sum of the x, y, and z values of a current time, not each absolute value related to the x, y, and z axes, and a critical point for determining whether an effective impact exists may be determined by calculating the raw data acquired through impact as a result value (G sensor value) by a predetermined operation (impact detection logic), and using these calculated values.

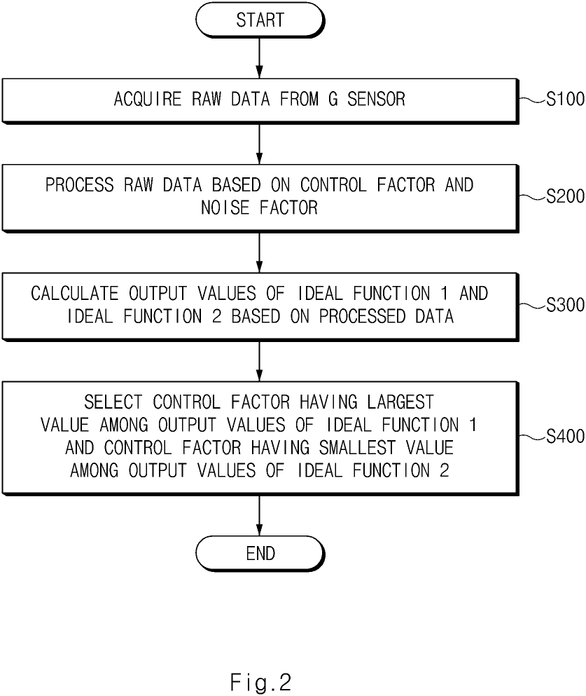

Hereinafter, a method of selecting a control factor for detecting a built-in cam impact will be described in detail with reference to FIG. 2. FIG. 2 illustrates a flowchart showing a method of deriving a control factor for detecting a built-in cam impact according to an exemplary embodiment of the present disclosure.

Hereinafter, it is assumed that the built-in cam impact detection improving apparatus 100 of FIG. 1 performs a process of FIG. 2. In addition, in the description of FIG. 2, operations described as being performed by a device may be understood as being controlled by the processor 130 of the built-in cam impact detection improving apparatus 100.

The built-in cam impact detection improving apparatus 100 may acquire raw data from the G sensor 200 through a principle test (S100). The raw data refers to a difference between a vector sum of x, y, and z values before a reference time and a vector sum of the x, y, and z values of a current time, not each absolute value related to the x, y, and z axes. In other words, the raw data acquired through the impacts may be calculated as a result value (G sensor value) by a predetermined operation (impact detection logic), and a critical point may be determined by using such calculated values.

In this case, the principle test may be performed, e.g., through Steps 1 to 4 below.
1. Strike hammer strikes 15 striking points per vehicle.
2. For each hitting angle of 30 degrees and hitting angle of 70 degrees, apply 10 blows for each point and angle.
3. Perform Steps 1 and 2 for each passenger vehicle and SUV vehicle.
4. Perform a total of 1440 principle tests depending on the conditions of Steps 1 to 3.

The raw data may be obtained from the total of 1440 principle tests.

The built-in cam impact detection improving apparatus 100 may process the raw data based on a control factor and a noise factor (S200). That is, the built-in cam impact detection improving apparatus 100 may apply each level (3 levels) of the control factors (4) to each of 1440 pieces of raw data. The built-in cam impact detection improving apparatus 100 may obtain a hitting value for a hitting angle of 70 degrees for each level of each control factor depending on the orthogonal table, a hitting value for a hitting angle of 30 degrees, a number of hitting points, and a standard deviation for 10 times for each hitting point and angle, etc.

The built-in cam impact detection improving apparatus 100 may calculate output values of Ideal function 1 and Ideal function 2 based on processed data (S300). That is, the output values of Ideal function 1 and Ideal function 2 may be calculated by computing indexes and correlation of the processed data. That is, the built-in cam impact detection improving apparatus 100 may calculate the output values of Ideal function 1 and Ideal function 2 through Equations 1 and 2, respectively, based on the processing data such as the hitting value for the hitting angle of 70 degrees for each level of each control factor, the hitting value for the hitting angle of 30 degrees, the number of hitting points, and the standard deviation for 10 times for each hitting point and angle, etc.

The built-in cam impact detection improving apparatus 100 may select a control factor having a largest value among the output values of Ideal function 1 and a level of the control factor, and select a control factor having a smallest value among the output values of Ideal function 2 and a level of the control factor (S400).

That is, according to the present disclosure, accuracy of impact detection may be increased by applying a selected control factor and determining a threshold value for determining an effective impact by selecting a control factor with a small standard deviation for magnitudes of the same impacts and a large ratio of effective and non-effective impacts.

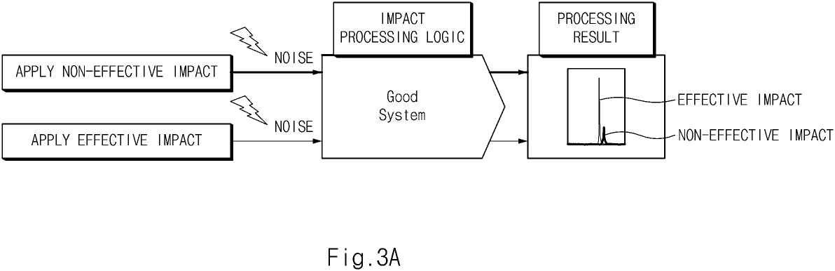

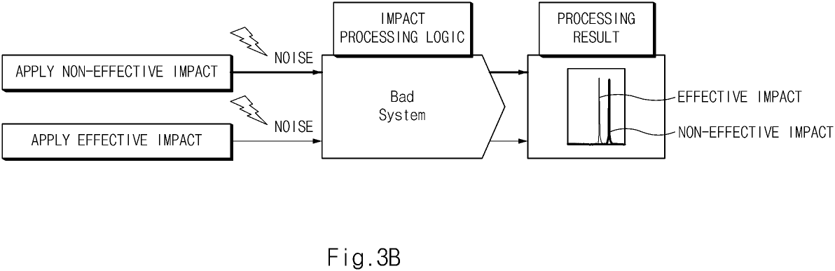

FIG. 3A and FIG. 3B illustrate views for describing an example of a difference between an effective impact and an ineffective impact in order to improve impact detecting performance of a built-in cam according to an exemplary embodiment of the present disclosure.

FIG. 3A illustrates an example of a system with a large difference between an effective impact perceived as an impact and an ineffective impact not recognized as an impact, and FIG. 3B illustrates an example of a system with a small difference between the effective impact and the ineffective impact. The present disclosure seeks to find a condition of a control factor with a large difference between the effective impact and the ineffective impact.

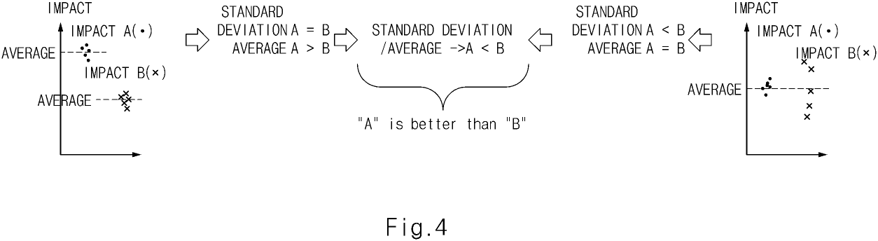

FIG. 4 illustrates a view for describing an example of a standard deviation for same impacts to improve impact detection performance of a built-in cam according to an exemplary embodiment of the present disclosure.

Referring to FIG. 4, in the case where an impact sample group A and an impact sample group B exist, when standard deviations of the impact sample group A and the impact sample group B are the same, but an average impact amount of the impact sample group A is greater than that of the impact sample group B, a value obtained by dividing a standard deviation by an average in the impact sample group B is greater than a value obtained by dividing a standard deviation by an average in the impact sample group A. In addition, when the standard deviation of the impact sample group A is smaller than that of the impact sample group B, but averages of the impact sample group A and the impact sample group B are the same, the value obtained by dividing the standard deviation by the average in the impact sample group B is greater than the value obtained by dividing the standard deviation by the average in the impact sample group A. As a result, it may be seen that the impact sample group A has a smaller standard deviation for the same impacts than that of the impact sample group B.

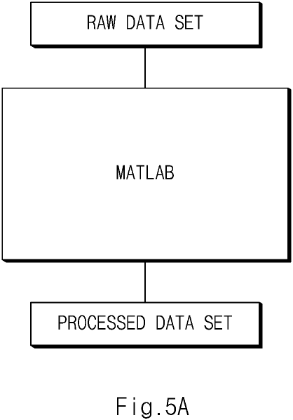

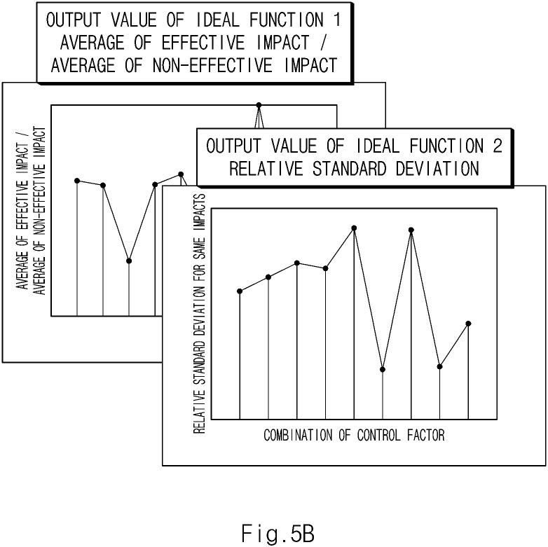

FIG. 5A illustrates a view for describing an example of calculating a data set that is processed by using raw data of a built-in cam impact detection improving apparatus according to an exemplary embodiment of the present disclosure, and FIG. 5B illustrates a view for describing an example of calculating an output value of each of Ideal function 1 and Ideal function 2 by using the processed data set of FIG. 5A.

Referring to FIG. 5A, the built-in cam impact detection improving apparatus 100 may process each control factor combination and outputs a processed data set based on a raw data set obtained through the principle test is transferred through MATLAB.

Referring to FIG. 5B, Ideal function 1 and Ideal function 2 each may output an output value by using the processed data set. An output value of ideal function 1 indicates a ratio of averages of the effective and ineffective impacts, and an output value of Ideal function 2 indicates a relative standard deviation for same impacts.

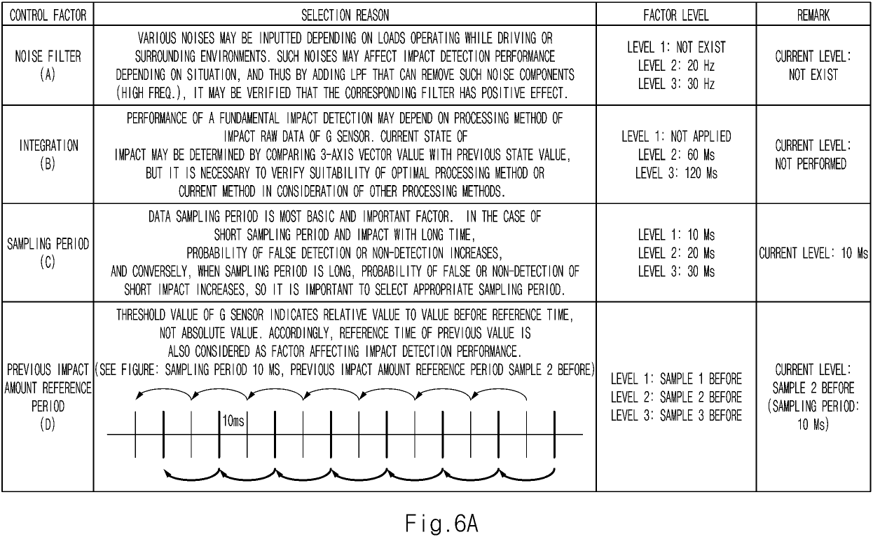

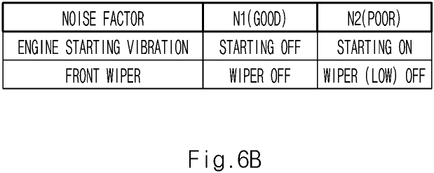

FIG. 6A illustrates a table for describing a control factor for detecting a built-in cam impact according to an exemplary embodiment of the present disclosure, and FIG. 6B illustrates a table for describing a noise factor for detecting a built-in cam impact according to an exemplary embodiment of the present disclosure.

The output values of Ideal function 1 and Ideal function 2 may be determined based on the control factor as illustrated in FIG. 6A and the noise factor as illustrated in FIG. 6B.

The control factor may include a noise filter A, an integration B, a sampling period C, and a previous impact amount reference period D.

arious noises may be inputted depending on loads operating while driving or surrounding environments. Such noises may affect impact detection performance depending on a situation, and thus by adding a low pass filter (LPF) that can remove such noise components (high Freq.), it may be verified that the corresponding filter has a positive effect. Accordingly, it includes the noise filter A as a control factor. The noise filter A may be divided into Level 1, Level 2, Level 3, and the like. For example, when the noise filter is Level 1, there may be no noise filtering value as a control factor, when the noise filter is Level 2, the noise filtering value may be set to 20 Hz, and when the noise filter is Level 3, it may be set to 30 Hz.

Performance of a fundamental impact detection may depend on a processing method of an impact raw data of the G sensor 200, a current state of impact may be determined by comparing a 3-axis vector value with a previous state value, but integration B included as a control factor for a need to verify suitability of an optimal processing method or a current method in consideration of other processing methods.

The integration B may be divided into Level 1, Level 2, Level 3, and the like. For example, when the integration B is Level 1, the integration may not be applied as a control factor, when the integration B is Level 2, result values from a time before 60 ms are integrated (SUM), and when the integration B is Level 3, result values from a time before 120 ms are integrated (SUM).

In addition, the sampling period C may be included as a control factor. The data sampling period is a most basic and important factor. In the case of a short sampling period and an impact with a long time, probability of false detection or non-detection increases, and conversely, when the sampling period is long, probability of false or non-detection of a short impact increases, so it is important to select an appropriate sampling period. The sampling period C may be divided into Level 1, Level 2, Level 3, and the like. For example, when the sampling period is Level 1, the sampling period may be set to 10 ms, when it is Level 2, it may be set to 20 ms, and when it is Level 3, the sampling period may be set to 30 ms.

In addition, the previous impact amount reference period D may be included as a control factor. A threshold value of the G sensor indicates a relative value to a value before a reference time, not an absolute value. Accordingly, a reference time of the previous value may also be considered as a factor affecting impact detection performance. The previous impact amount reference period D may be divided into Level 1, Level 2, Level 3, and the like. For example, when the previous impact amount reference period D is Level 1, it may be set to 1 sample before, when it is Level 2, it may be set to 2 samples before, and when it is Level 3, it may be set to 3 samples before. FIG. 6A illustrates an example in which the sampling period is 10 ms and the previous impact amount reference period is 2 samples before.

In the past, a noise filter and integration may not be used as control factors, and the sampling period may be collectively used as 10 ms, and the previous impact amount reference period may be collectively used as 2 samples before.

Accordingly, in the present disclosure, the noise filter A, the integration B, the sampling period C, and the previous impact amount reference period D may all be used as control factors, and all the number of cases for each level may be implemented by dividing a level of each control factor into three.

FIG. 6B illustrates a noise factor, which may include a start vibration and whether the front wiper is operated. That is, it is possible to consider noises at times of ignition off and ignition on, and noises at times of wiper off and wiper on.

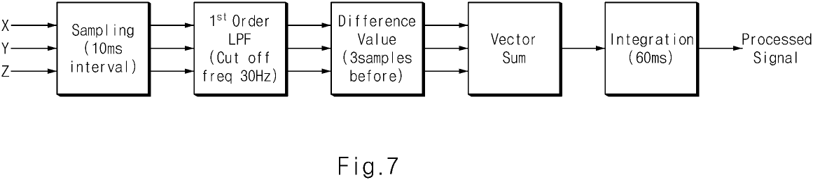

FIG. 7 illustrates a block diagram showing a process of calculating a data set that is processed by using raw data according to an exemplary embodiment of the present disclosure. Referring to FIG. 7, it can be expressed as illustrated in FIG. 7 by reflecting a MATLAB simulation for raw data.

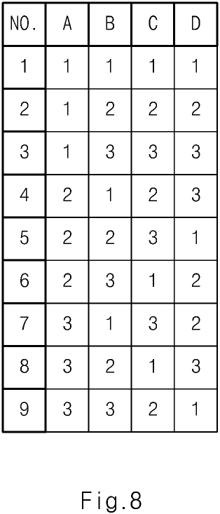

FIG. 8 illustrates an example of an orthogonal table including a number of cases for a control factor for detecting a built-in cam impact according to an exemplary embodiment of the present disclosure.

Referring to FIG. 8, when each of the four control factors A, B, C, and D is set to 3 levels, 3⁴, a total of 81 cases may occur. Accordingly, FIG. 8 illustrates an example of an orthogonal table for 9 cases out of 81 cases. The orthogonal table for the number of such cases may be determined in advance by experimental values.

That is, as illustrated in FIG. 8, in the case of No. 1, levels of the control factors A, B, C, and D may be all 1. In the case of No. 2, the level of the control factor A is 1, and the levels of the remaining control factors B, C, and D is 2. As such, numbers of cases may be combined for each level of each control factor, to calculate the output values of Ideal function 1 and Ideal function 2 for each of the number of cases.

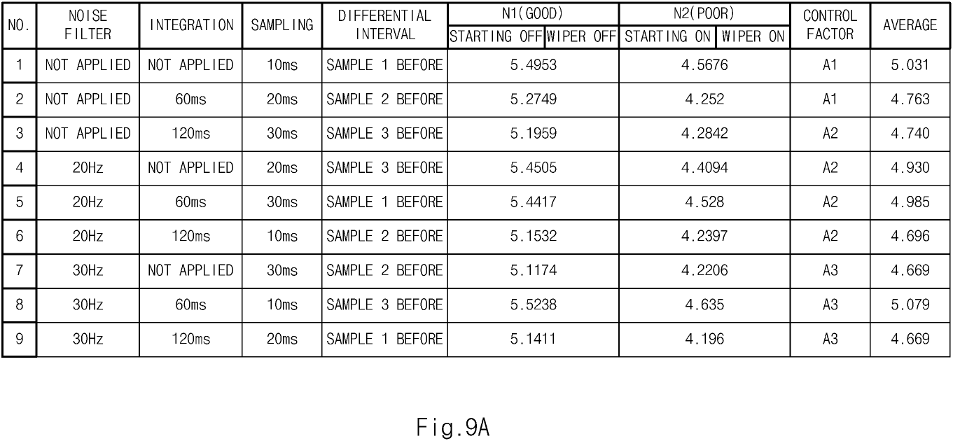

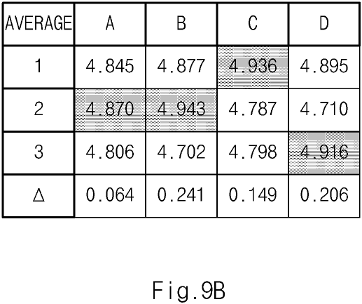

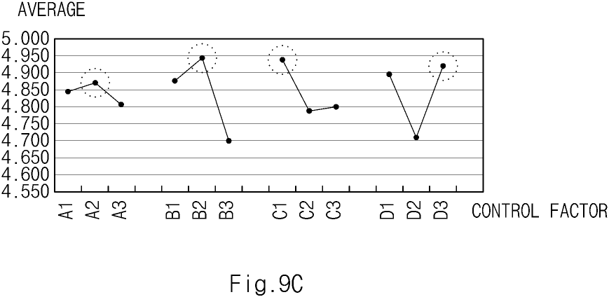

FIG. 9A to FIG. 9C illustrate views for describing an example of calculating an output value by Ideal function 1 according to an exemplary embodiment of the present disclosure.

Referring to FIG. 9A, when applying it for each level of each control factor depending on the orthogonal table of FIG. 8, an average value, which is the output value of Ideal function 1, may be calculated. In this case, the average value of the output values at starting as a noise factor and a wiper on state and the output values at starting and a wiper off state becomes the output value of No.1. When the level of the noise filter is 1, that is, when it is not applied, average values of a control factor A1 are 5.031, 4.763, and 4.740.

In FIG. 9B, A1 becomes 4.845, which is an average value of 5.031, 4.763, and 4.740. As such, average values of A1, A2, and A3 may be calculated, and B1, B2, and B3 may also be calculated in the same manner. In this case, an average change amount (Δ) is a difference between a largest value and a smallest value among A1, A2, and A3. When each average value in FIG. 9B is shown on a graph, it is the same as in FIG. 9C, and the values of A, B, C, and D are indicated, and a largest value among them is indicated by a circle. It may be seen that the two control factors with a large average change are B and D, and a large average change indicates a large influence.

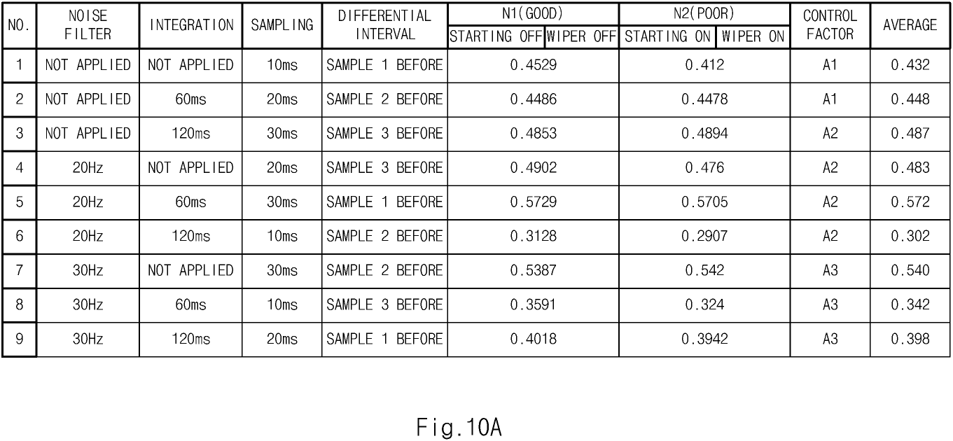

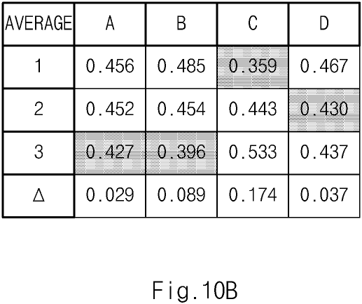

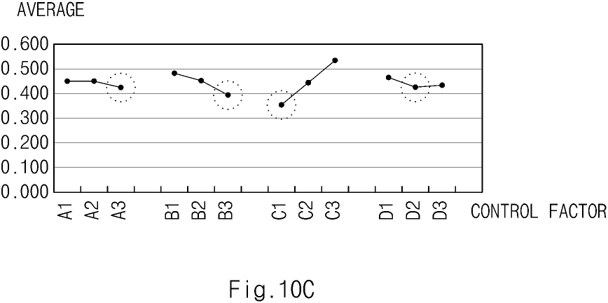

FIG. 10A to FIG. 10C illustrate views for describing an example of calculating an output value by Ideal function 2 according to an exemplary embodiment of the present disclosure.

Referring to FIG. 10A, when applying it for each level of each control factor depending on the orthogonal table of FIG. 8, an average value, which is the output value of Ideal function 2, may be calculated. In this case, the average value of the output values at starting as a noise factor and a wiper on state and the output values at starting and a wiper off state becomes the output value of No.1. When the level of the noise filter is 1, that is, when it is not applied, average values of a control factor A1 are 0.432, 0.448, and 0.487.

In FIG. 10B, A1 becomes 0.456, which is an average value of 0.432, 0.448, and 0.487. As such, average values of A1, A2, and A3 may be calculated, and B1, B2, and B3 may also be calculated in the same manner. In this case, an average change amount (Δ) is a difference between a largest value and a smallest value among A1, A2, and A3. When each average value in FIG. 10B is shown on a graph, it is the same as in FIG. 10C, and the values of A, B, C, and D are indicated, and a smallest value among them is indicated by a circle. It may be seen that the two control factors with a large average change are B and C, and a large average change indicates a large influence.

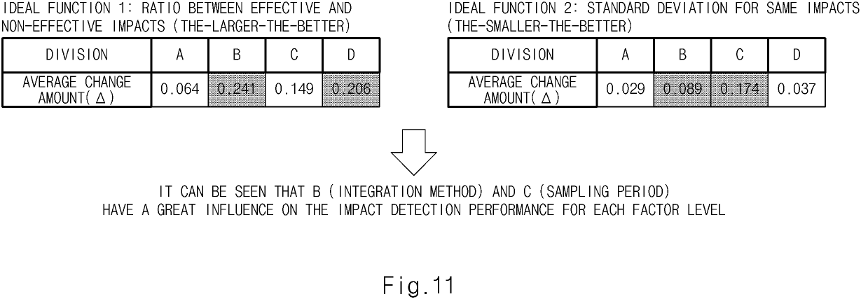

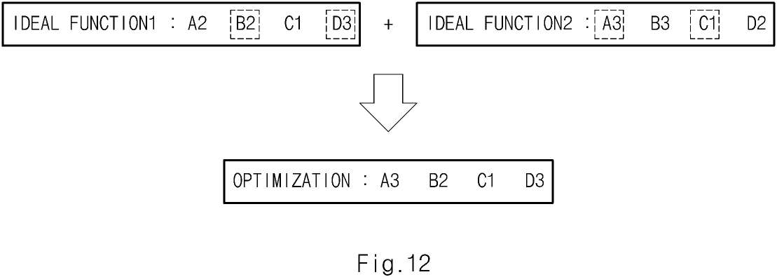

FIG. 11 illustrates a view for describing an example of an average change amount for each control factor of Ideal function 1 and Ideal function 2 according to an exemplary embodiment of the present disclosure, and FIG. 12 illustrates a view for describing a process of finally selecting a control factor having a large influence among average change amounts of FIG. 11.

Referring to FIG. 11, an average change amount of the output value of Ideal function 1 of FIG. 9B and an average change amount of the output value of Ideal function 2 of FIG. 10B are illustrated.

The control factors with a large average change amount of the output value of Ideal function 1 are B and D, and the control factors with a large average change amount of the output value of Ideal function 2 are B and C.

Accordingly, it can be seen that B (integration method) and C (sampling period) have a great influence on the impact detection performance for each factor level.

Referring to FIG. 12, based on the output value and the average change amount of Ideal function 1 of FIG. 9B, factors with a largest average change amount are B and D, and values with a largest output value of Ideal function 1 are B2 and D3 in FIG. 9B.

In addition, based on the output value and the average change amount of Ideal function 2 of FIG. 10B, factors with a largest average change amount are B and C, and values with a smallest output value of Ideal function 2 are B3 and C1 in FIG. 10B.

Accordingly, optimal control factors from Ideal function 1 and Ideal function 2 are B2, D3, B3, and C1, and the control factors B include two control factors B2 and B3, so one of them can be selected. In addition, A3, which has a relatively large influence among control factors A, may be selected.

As such, control factors A, B, C, and D may be evenly selected from Ideal function 1 and Ideal function 2, when two specific control factors are selected, one of the two control factors is selected depending on a predetermined reference value, and a control factor having a relatively large influence among the control factors that is not selected may be selected.

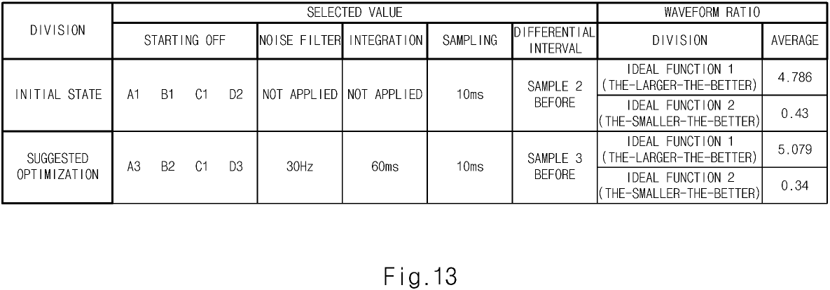

FIG. 13 illustrates a view for comparing output values of Ideal function 1 and Ideal function 2 of an optical control factor and an existing control factor according to an exemplary embodiment of the present disclosure.

Referring to FIG. 13, it can be seen that average values of the optimization control factors A3, B2, C1, and D3 of the present disclosure show more improved results as the output value (average value) of Ideal function 1 becomes larger than the existing control factors A1, B1, C1, and D2, and the output value of Ideal function 2 becomes smaller.

It can be seen that a distinction between effective and ineffective signals is clearest and consistency of data for same impacts is increased when combination of optimization control factors A3, B2, C1, and D3 of the present disclosure is applied.

As such, according to the present disclosure, a threshold for impact detection may be set and impacts may be detected by selecting the control factor with a clearest ratio between effective and non-effective impacts and with highest data consistency (with the smallest standard deviation) for the same impacts and a level of the control factor.

In addition, according to the present disclosure, it is possible to accurately detect a case (rolling impact) when a vehicle parked at an N stage impacts a parked host vehicle by applying integration as a control factor.

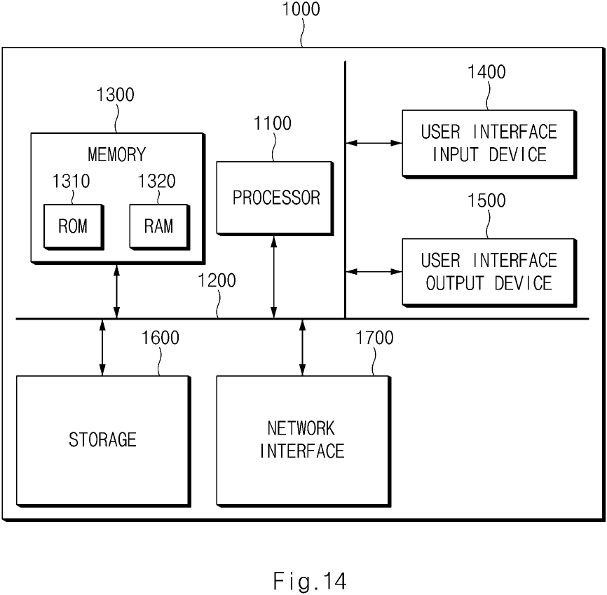

FIG. 14 illustrates a computing system according to an exemplary embodiment of the present disclosure.

Referring to FIG. 14, the computing system 1000 may include at least one processor 1100 connected through a bus 1200, a memory 2000, a user interface input device 1300, a user interface output device 1500, and a storage 1600, and a network interface 1700.

The processor 1100 may be a central processing unit (CPU) or a semiconductor device that performs processing on commands stored in the memory 2000 and/or the storage 1600. The memory 2000 and the storage 1600 may include various types of volatile or nonvolatile storage media. For example, the memory 2000 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 2000 and/or the storage 1600) such as a RAM memory, a flash memory, a ROM memory, an EPROM memory, an EEPROM memory, a register, a hard disk, a removable disk, and a CD-ROM.

An exemplary storage medium may be coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. An apparatus for improving an impact detecting performance of a built-in cam comprising:
a processor configured to select a control factor for determining impacts and a level of the control factor by using a ratio between effective impacts and ineffective impacts and a standard deviation of impact detection values for same impacts, wherein the ratio and the standard deviation are calculated by using data obtained from a sensor for vehicle impact detection; and
a storage configured to store data and algorithms driven by the processor.

2. The apparatus for improving an impact detecting performance of a built-in cam of claim 1, wherein
the processor is further configured to select the control factor and the level of the control factor by using a the-larger-the-better characteristic indicating a better characteristic as the ratio between the effective impacts and the ineffective impacts is larger and a the-smaller-the-better characteristic indicating a better characteristic as the standard deviation of the impact detection values for the same impacts is smaller.

3. The apparatus for improving an impact detecting performance of a built-in cam of claim 1, wherein
the processor is further configured to process the data to calculate processing data for each combination of a plurality of control factors.

4. The apparatus for improving an impact detecting performance of a built-in cam of claim 3, wherein
the processor is further configured to obtain an average of hitting values for each hitting point and hitting angle, a standard deviation of hitting values for each hitting point and hitting angle, and a number of hitting points by applying each level of the control factors.

5. The apparatus for improving an impact detecting performance of a built-in cam of claim 4, wherein
the processor is further configured to calculate an average value of the effective impacts and an average value of the ineffective impacts based on the processing data for each level combination of the control factors, to calculate a ratio between the average value of the effective impacts and the average value of the ineffective impacts.

6. The apparatus for improving an impact detecting performance of a built-in cam of claim 5, wherein
the processor is further configured to use the average of the hitting value for each hitting point and hitting angle and the number of the hitting points for each level combination of the control factors, to calculate the ratio between the average value of the effective impacts and the average value of the ineffective impacts.

7. The apparatus for improving an impact detecting performance of a built-in cam of claim 5, wherein
the processor is further configured to select a level of the calculated control factors for which a largest value among ratios of the average value of the effective impacts and the average value of the ineffective impacts is calculated for each level combination of the control factors.

8. The apparatus for improving an impact detecting performance of a built-in cam of claim 5, wherein
the processor is further configured to calculate a standard deviation of impact detection values for the same impacts based on the processing data for each level combination of the control factors.

9. The apparatus for improving an impact detecting performance of a built-in cam of claim 8, wherein
the processor is further configured to use the standard deviation and the number of hitting points for each hitting point and hitting angle for each level combination of the control factors, to calculate the standard deviation of the impact detection values for the same impacts.

10. The apparatus for improving an impact detecting performance of a built-in cam of claim 8, wherein
the processor is further configured to select a control factor for which a smallest value among standard deviations of the impact detection values for the same impacts for each level combination of the control factors is calculated and a level of the calculated control factor.

11. The apparatus for improving an impact detecting performance of a built-in cam of claim 10, wherein
the processor is further configured to:
calculate an average change amount of n output values for each control factor depending on a combination of a number of the control factors and a number of levels,
determine that a control factor with an average change amount of each of the control factors that is greater than or equal to a predetermined reference value has a large effect on impact detection, and
select a control factor with the average change amount that is equal to or greater than the predetermined reference value.

12. The apparatus for improving an impact detecting performance of a built-in cam of claim 11, wherein
the processor is further configured to:
select a level when the ratio between the average value of the effective impacts and the average value of the ineffective impacts is largest among the n output values in the selected control factor, and
select a smallest level of the standard deviation of the impact detection values among the n output values.

13. The apparatus for improving an impact detecting performance of a built-in cam of claim 4, wherein
the processor is further configured to:
generate an orthogonal table for each level of the control factors, and
generate an orthogonal table comprising numbers of cases as many as a number of levels multiplied by a number of control factors.

14. The apparatus for improving an impact detecting performance of a built-in cam of claim 13, wherein
the processor is further configured to calculate the ratio between the effective impacts and the ineffective impacts for each of the numbers of cases and the standard deviation of the impact detection values for the same impacts.

15. The apparatus for improving an impact detecting performance of a built-in cam of claim 1, wherein
the control factor comprises a noise filter, integration of an impact amount, an impact amount sampling period, and a previous impact amount reference period.

16. The apparatus for improving an impact detecting performance of a built-in cam of claim 1, wherein
the processor is further configured to consider whether an engine is started, or a wiper is operated to select the control factor and a level of the control factor.

17. A method for improving an impact detecting performance of a built-in cam, the method comprising:
acquiring data from a sensor for vehicle impact detection; and
selecting a control factor for determining impacts and a level of the control factor by using a ratio between effective impacts and ineffective impacts and a standard deviation of impact detection values for same impacts,
wherein the ratio and the standard deviation are calculated by using data obtained from a sensor for vehicle impact detection.

18. The improving method of claim 17, wherein
the selecting of the control factor and the level of the control factor comprises
selecting the control factor and the level of the control factor by using a the-larger-the-better characteristic indicating a better characteristic as the ratio between the effective impacts and the ineffective impacts is larger and a the-smaller-the-better characteristic indicating a better characteristic as the standard deviation of the impact detection values for the same impacts is smaller.

19. The improving method of claim 17, wherein
the selecting of the control factor for determining the impacts and the level of the control factor comprises:
processing the data to calculate processing data for each combination of a plurality of control factors;
calculating an average value of the effective impacts and an average value of the ineffective impacts based on processing data for each level combination of the control factors, to calculate a ratio between the average value of the effective impacts and the average value of the ineffective impacts; and
selecting a control factor and a level of the control factor for which a largest value among ratios of the average value of the effective impacts and the average value of the ineffective impacts is calculated for each level combination of the control factors.

20. The improving method of claim 19, wherein
the selecting of the control factor for determining the impacts and the level of the control factor comprises:
calculating a standard deviation of impact detection values for the same impacts based on the processing data for each level combination of the control factors;
selecting a control factor for which a smallest value among standard deviations of the impact detection values for the same impacts for each level combination of the control factors is calculated and a level of the calculated control factor;
calculating an average change amount of n output values for each control factor depending on a combination of a number of the control factors and a number of levels; and
determining that a control factor with an average change amount for each of the control factors that is greater than or equal to a predetermined reference value has a large effect on impact detection, and selecting a control factor with the average change amount that is equal to or greater than the predetermined reference value.
